(19) United States
(12) Patent Application Publication
(10) Pub. No.: US 2014/0056186 A1
(43) Pub. Date: Feb. 27, 2014

(54) METHODS, DEVICES AND COMPUTER PROGRAM PRODUCTS FOR INTERFERENCE REDUCTION IN TDD SYSTEMS ALLOWING ALLOCATION OF FLEXIBLE SUBFRAMES FOR UPLINK OR DOWNLINK TRANSMISSION

(71) Applicant: Renesas Mobile Corporation, Tokyo (JP)

(72) Inventors: Chunyan GAO, Beijing (CN); Erlin ZENG, Beijing (CN); Haiming WANG, Beijing (CN); Jing HAN, Beijing (CN)

(73) Assignee: Renesas Mobile Corporation, Tokyo (JP)

(21) Appl. No.: 14/069,450

(22) Filed: Nov. 1, 2013

Related U.S. Application Data
(63) Continuation of application No. PCT/CN2011/073600, filed on May 3, 2011.

(51) Int. Cl. H04W 28/04; H04W 72/04

(52) U.S. Cl. CPC H04W 28/048; H04W 72/0406
USPC 370/280

(57) ABSTRACT

The present invention proposes methods, devices and computer program products in relation to interference reduction, in particular for control channels in TDD systems allowing allocation of flexible subframes for uplink or downlink transmission. In relation thereto, a format of data transmission in flexible subframes in the uplink and/or downlink is modified.

### FIELD OF THE INVENTION

The present invention relates to methods, devices and computer program products for interference reduction in TDD systems allowing allocation of flexible subframes for uplink or downlink transmission. More specifically, the present invention relates to those methods and devices configured for TDD operation in a network environment, wherein a partition of subframes of channels are configurable to be flexibly assigned for downlink or uplink transmission while other subframes are fixedly configured for either uplink or downlink transmission, and to reduce interference on control channels in such environment.

### BACKGROUND

Mobile data transmission and data services are constantly making progress. With the increasing penetration of such services, a need for increased bandwidth for conveying the data is emerging. The more efficiently bandwidth is used, the higher the probability for interference gets. In particular, inference on control data or control channels is crucial as corrupted control data will adversely affect the entire system performance and operation.

Currently, a system known as Long Term Evolution, LTE, is being further developed. The present invention relates to its further development referred to as LTE-Advanced system (LTE-A), which will be part of 3GPP LTE Rel-11. More specifically, it focuses on the configuration of a TDD system in a local area scenario.

Allowing for asymmetric UL-DL allocations has been claimed as one benefit of deploying TDD system. The asymmetric resource allocation in LTE TDD is realized by providing seven different semi-statically configured uplink-downlink configurations. These allocations can provide (in uplink direction) between 40% and 90% of the DL subframes.

For TDD deployments in general, interference between UL and DL including both basestation-to-basestation and UE-to-UE interference needs to be considered. The DL-UL interference in a TDD network is typically handled by statically provisioning a guard period and adopting the same frame timing and uplink-downlink configuration practically in the entire network. However, in local area (LA) network, it may be of interest to consider different UL/DL allocations in the neighboring cells, since same DL/UL configuration may not match the traffic situation in different LA cells with a small number of users.

The main property as we consider for a LA network scenario is that the typical cell size is small comparing with a macro cell, and the number of UEs connected to each eNB (or A_{P}) in the network is not large. And also, LA network deployment maybe does not consider network planning and optimization. DL-UL interference is one obstacle to deploy flexible TDD LA network. Now, consider a TDD deployment scenario with each cell frame synchronized, but not switch point synchronized. In this case, if each cell chooses one TDD configuration from seven TDD configuration patterns defined, there is no DL-UL interference problem for subframe 0, 1, 2 and 5 since these subframes have fixed link direction in any TDD configurations defined.

For other subframes, their link direction can change with TDD configuration, and there can be DL-UL interference depending on the TDD configuration adopted in neighboring cells. Then, in this description, the subframes like 0, 1, 2 and 5 which have fixed link direction are called fixed subframe, while other subframes are called flexible subframe for simplicity. It is to be noted that the fixed subframe and flexible subframe can change depending on the TDD configurations allowed to be adopted, e.g, if a network only supports TDD configurations 1 and 2, then subframes 0, 1, 2, 4, 5, 6, 7, 9 are all fixed subframes, while subframes 3 and 8 are flexible subframes which are set as UL in TDD configuration 1 and DL in TDD configuration 2.

DL-UL interference in flexible subframes will degrade the SINR significantly. For data transmission in a flexible subframe, link adaptation and HARQ can help to adapt to the interference level, but for control signaling to be transmitted in the flexible subframe(s), it is more sensitive to the interference due to lack of HARQ, and it will further reduce the throughput.

One straightforward way to avoid DL-UL interference in control signaling is to limit all the control channels in the fixed subframes, but some disadvantages are identified for such methods:
there is increased DL control overhead in the fixed DL subframes;
by putting all control in fixed subframes, a new HARQ timing needs to be introduced which will increase the implementation complexity;
the interference to/from the data channel in the flexible subframes remains unsolved;
to protect UL control in PUCCH, there is also the proposal of reserving band edge PRBs for PUCCH use, and no PDSCH is allowed in this PRBs via scheduling restrictions. The problem here is that scheduling restriction can only avoid PDSCH transmissions in some PRBs, but PDCCH, PCFICH and CRS shall still be transmitted in edge PRBs to keep backward compatibility. Therefore, interference between PDCCH/PCFICH/CRS and PUCCH still exists.

Thus, there is still a need to further improve such systems in terms of proper interference reduction.

### SUMMARY

The present invention addresses such situation and proposes, in exemplary embodiments, new solutions to efficiently reduce the interference from/to DL control channels and interference from common reference signal, CRS, channels to uplink UL control channels.

Various aspects of examples of the invention are set out in the claims.

According to a first aspect of the present invention, there is provided

a device, comprising a transceiver module configured for TDD operation in a network environment, wherein a partition of subframes of channels are configurable to be flexibly assigned for downlink or uplink transmission while other subframes are fixedly configured for either uplink or downlink transmission, a controller module, configured to determine those subframes flexibly assigned for the uplink or downlink transmission, and to modify a format of data transmission in flexible subframes for at least control channels in downlink;
and as well there is provided
a method, comprising in a transceiving configuration for TDD operation in a network environment, wherein a partition of subframes of channels are configurable to be flexibly assigned for downlink or uplink transmission while other subframes are fixedly configured for either uplink or downlink transmission, determining those subframes flexibly assigned for the uplink or downlink transmission, and modifying a format of data transmission in flexible subframes for at least control channels in downlink.

Advantageous further developments are as set out in respective dependent claims thereof.

According to a second aspect of the present invention, there is provided

a device, comprising a transceiver module configured for TDD operation in a network environment, wherein a partition of subframes of channels are configurable to be flexibly assigned for downlink or uplink transmission while other subframes are fixedly configured for either uplink or downlink transmission, a controller module, configured to receive an indication of those subframes determined to be flexibly assigned for the uplink or downlink transmission, and to modify a format of data transmission in flexible subframes in uplink;
and as well there is provided
a method, comprising in a transceiving configuration for TDD operation in a network environment, wherein a partition of subframes of channels are configurable to be flexibly assigned for downlink or uplink transmission while other subframes are fixedly configured for either uplink or downlink transmission, receiving an indication of those subframes determined to be flexibly assigned for the uplink or downlink transmission, and modifying a format of data transmission in flexible subframes in uplink.

Advantageous further developments are as set out in respective dependent claims thereof.

According to a third aspect of the present invention, there are provided computer program products comprising computer-executable components which, when executed on a computer, are configured to implement the respective methods as set our herein above. The above computer program product/products may be embodied as a computer-readable storage medium.

Thus, improvement is achieved by those methods, devices and computer program products, in that at least in connection with exemplary embodiments:
interference on both, control and data channels are minimized,
the resource efficiency is controllable at eNB side, e.g, it can let one UE to use 13 out of the 14 OFDM symbols when finding potential high interference, while let another UE to occupy all the OFDM symbols. This enables to get a balance between interference level and resource efficiency, and helps to result in higher system throughput,
the CRS overhead is reduced and at the same time the interference from/to CRS in the cell is minimized.

Common to all the proposals and/or exemplary embodiments, the control channel is allowed in the flexible subframes, which avoids control channel overload in the fixed subframes.

Thus, with the present invention implemented, solutions to handle the DL-UL interference problem introduced by cell-specific TDD configuration in LA network scenario is improved.

### BRIEF DESCRIPTION OF DRAWINGS

For a more complete understanding of example embodiments of the present invention, reference is now made to the following descriptions taken in connection with the accompanying drawings in which:

FIG. 1 schematically illustrates determination of flexible subframes with cell-coordination (FIG. 1a) and without cell coordination (FIG. 1b);

FIG. 2 schematically illustrates an example of interference reduction applied to a PDCCH in a flexible subframe.

### DESCRIPTION OF EXEMPLARY EMBODIMENTS

Exemplary aspects of the invention will be described herein below.

It is to be noted that the following exemplary description refers to an environment of the LTE system (Long Term Evolution) and/or local area (LA) networks thereof. However, it is to be understood that this serves for explanatory purposes only. Other systems differing from the LTE system can be adopted as long as they deploy similar configurations and enable asymmetric resource allocation for uplink and downlink transmission to/from an access point such as an evolved Node_B, eNB. Generally, aspects of the present invention can be deployed in relation to any TDD system (time division duplex) allowing for flexible allocation of transmission frames in terms of the link direction, i.e. uplink UL or downlink DL.

A respective eNB as an access point in the broadest sense communicates with one or more terminal devices, referred to also as user equipment UE, using control channels as well as payload channels. A user equipment can be a mobile phone, a smart phone or personal computer connectable to a network such as LTE network or other (WCDMA, WIMAX, WLAN or the like) as long as they deploy TDD.

In at least exemplary embodiments, to reduce the DL-UL interference, more specifically the interference from/to PCFICH/PDCCH and interference from DL CRS, the following two exemplary embodiments are proposed. Basically, at least exemplary embodiment #1 is to reduce interference from/to PDCCH/PCFICH, while exemplary embodiment #2 is to reduce interference from CRS. Nonetheless, by combining the proposal, also combined advantageous effects are obtainable.

### Exemplary Embodiment #1

The PCFICH in a flexible subframe of neighboring cells is known to each eNB. As to the value of the PCFICH, the PCFICH value can be hard-coded for a LA TDD network with flexible TDD; but the PCFICH value can also be determined or exchanged via eNB communication in a LA network.

The PCFICH value is informed to the UE and/or UE's. That is, the PCFICH value can be sent to UEs by serving eNB in the following methods:
It can be sent in the same way as in fixed subframe, i.e, using the REs reserved for PCFICH;
The PCFICH value is signaled to UE via system information, or RRC signaling, in the fixed DL subframe to guarantee accuracy;
The PCFICH value is sent to UEs using the REs reserved for PCFICH, and then repeated in some predefined PHICH resources to improve the performance;
The PCFICH value can also be implicitly derived by UE based on the flexible TDD configuration;

The PCFICH value applies to all flexible subframes in one configuration period, which can be all subframes except subframe 0, 1, 2, 5, or can be signaled to a UE by the eNB based on the coordination results between eNBs.

In flexible DL subframe, PDCCH is transmitted in the first i OFDM symbols, where i is the PCFICH value of own cell. For a LA with small number of users, i=1 is enough for most cases, (or, for data transmission, a MBSFN subframe format is allowed/used, as set out in other details in regard to the 2^{nd} exemplary embodikent)

In flexible UL subframe, PUSCH/PUCCH (i.e. a shared (data) channel and/or a control channel) is configurable to transmit in all OFDM symbols or only in the last 14-j OFDM symbols with shortened format, where j is determined based on PCFICH value (i) in flexible subframe of neighboring cells. The eNB can configure one UE to use short format for PUCCH, PUSCH or both. In case that some edge PRBs are reserved for PUCCH, then it will not be used in flexible DL subframes in neighboring cell, and in that case, the PUCCH may not necessarily need to be modified to use short format (since no interference in the reserved resource is expected to occur).

For cell central UEs, those can use normal length, while for cell edge UEs, those are configured to use shortened format to avoid DL-UL interference to/from PDCCH.

Note that i=j=1 is one special case, where the PCFICH value is fixed to be 1 for all cells, and in this case, no inter-eNB coordination in terms of the value of PCFICH is needed. Nevertheless, in other cases, the PCFICH value can be determined in each cell independently as in a macro cell, e.g., based on the bandwidth and the number of UEs to be scheduled. Then, due to a different situation in each cell, the PCFICH value can be different, and, inter-eNB communication on this value is needed.

For j=1, the shortened format is similar as the shortened PUSCH format in R8/R10 for subframes with SRS configuration.

Although hereinbefore it has been mentioned to transmit in DL only in the first i OFDM symbols and to transmit in UL in the last 14-j OFDM symbols, it could be the other way around. Moreover, the selection does not need to be limited to the first or last symbols, but could also apply to one or more “non-edge” symbols. For example, configuration could be such to transmit in DL in one or more OFDM symbols “in the middle” of the 14 OFDM symbols, and to transmit in UL in the complementary ones surrounding those used for DL transmission. That is, as a particular example, in DL OFDM symbols no 6 & 7 (out of 14) might be selected, and in UL OFDM symbols 0-5 and 8-13 might then be selected (this might imply values of i and j differing from each other and different from 1).

### Exemplary Embodiment #2

The flexible subframe, when set to be DL, is automatically configured to be a MBSFN subframe.

In this way, CRS is only transmitted in PDCCH region and new UEs supporting the flexible TDD will demodulate based on DRS, rather than CRS. Then, the interference from DL RS to neighbor cell's UL transmission can be reduced.

Since all flexible DL subframes are implicitly/automatically set as MBSFN, it helps to save configuration signaling.

Now, it is more specifically referred to the drawings and exemplary embodiments illustrated therein. This section gives some examples to show how interference on control channel(s) can be reduced by adopting the above proposal or proposals.

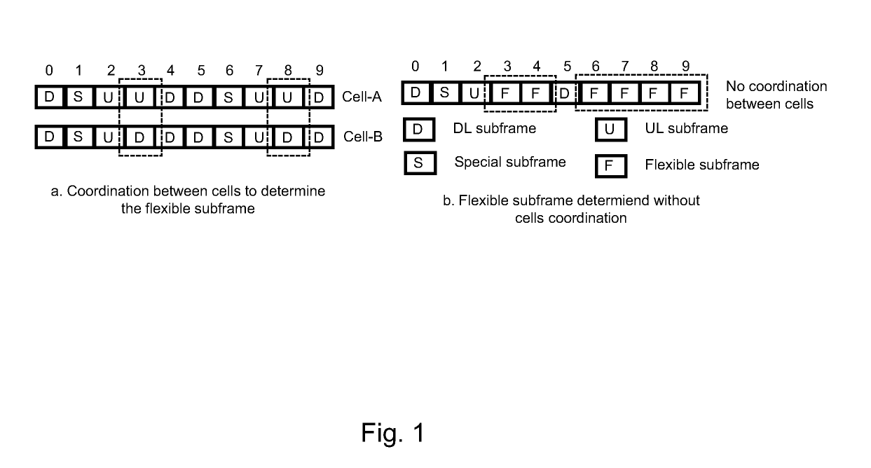

Since the proposed solution is applied to flexible subframes only, then the first step is to determine the flexible subframes. In FIG. 1, two different examples are given.

FIG. 1.a is the example with cell coordination, where cell A adopts TDD configuration 1 and cell B adopts TDD configuration 2, then after eNB communication, subframes 3 and 8 are seen as flexible subframes which have different link direction in different cells and will experience DL-UL interference. This is illustrated by the dotted lines surrounding subframes 3 and 8, respectively. (Note that after a cycle of 10 subframes numbered #0 to #9, a cycle is repeated.)

In the example of FIG. 1.b, no eNB communication (exchange of information between eNBs in regard of the TDD configuration) is assumed to take place on the adopted TDD configuration, and subframes except subframes 0, 1, 2, 5 are all seen as flexible subframes. This set of flexible subframes is signaled to UEs in each cell by the serving eNB. Stated in other words, in case of no communication among eNBs on the flexible subframes, it is assumed that the maximum number of potentially flexible subframes are flexible.

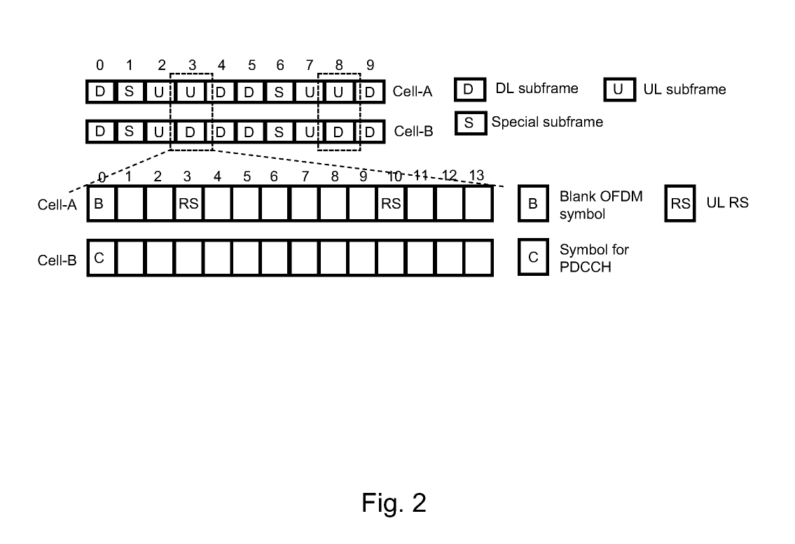

In FIG. 2, there is one example to show how interference on control channel(s) in one flexible subframe can be reduced based on the proposal or proposals in line with this at feast an exemplary aspect of the present invention.

In this example, the situation of FIG. 1.a is referred to. That is, in the upper part of FIG. 2, a copy of FIG. 1.a is illustrated and the assigned link direction DL (D) or UL (U) as well as whether it is a special (5) subframe is indicated for each subframe for cells A and B respectively. Like in FIG. 1.a, flexible subframes used for different link directions in cell A and B, respectively, are subframes #3 and #8.

Namely, the flexible subframe (#3 and #8) is configured to be UL in cell A, and configured to be DL in neighboring cell B. It is to be noted that in LA network, we can assume small number of UEs in each cell, then PCFICH=1 is enough for control of payload in most cases, so, here we assume the PCFICH value is set to be n=1, this can be signaled by eNB to UEs in a fixed subframe together with the signaling for flexible subframe set indication. This can also be signaled to UEs by other methods referred to and listed herein above.

The PDCCH for UEs in cell B is transmitted only in the 1^{st} OFDM symbol, as shown in FIG. 2 for cell B indicated by “C” placed in OFDM symbol numbered #0. While, in cell A, cell-edge UEs are configured to use the last 13 OFDM symbols for PUSCH transmission. This is represented by blanking the first OFDM symbol indicated by “B” placed in that OFDM symbol numbered #0. This part of FIG. 2 thus is particularly applicable for UEs located at the edge of cell A and potentially being more likely to “suffer” from interference from the neighboring cell(s).

But cell center UEs in cell A can still be configured to use normal PUSCH length, i.e, use all the OFDM symbols. By adopting the proposed method, firstly, the ambiguity potentially caused by PCFICH error is avoided, and this helps improve the control channel detection performance and data throughput; Secondly, interference from cell A's PUSCH to cell B's PDCCH is avoided. At the same time, the interference from cell B's PDCCH to cell A's PUSCH is avoided.

In exemplary embodiment #2, it is proposed to set the flexible DL subframe to be a MBSFN subframe. Since CRS has to guarantee larger coverage, then it cause more interference than the DRS. This proposal helps to avoid CRS in PDSCH part, then reduce the interference to neighbor cells.

From the above examples, the following advantages can be perceived:
Control channels are given high protection;
It is clear that the resource efficiency is controllable at eNB side, e.g, it can let one UE to use 13 out of the 14 OFDM symbols when finding potential high interference, while let another UE to occupy all the OFDM symbols; This enables to get a balance between interference level and resource efficiency, and helps to results in higher system throughput;
Interference from DL RS is reduced, since CRS, which has larger coverage than DRS, is restricted only in the PDCCH region.

These proposals according to the exemplary embodiments #1 and #2 can be applied in combination to get more efficient interference reduction.

Generally, the invention is implemented in an environment such as LTE system adopting a local area scenario. Exemplary embodiments of the invention are represented by methods and/or correspondingly configured devices such as eNBs and/or UEs. More specifically, the invention generally relates to modules of such devices. Other systems can benefit also from the principles presented herein as long as they have identical or similar properties like the TDD under LTE allowing for asymmetric UL-DL resource allocation.

Embodiments of the present invention may be implemented in software, hardware, application logic or a combination of software, hardware and application logic. The software, application logic and/or hardware generally, but not exclusively, may reside on the devices' modem module. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

The present invention relates in particular but without limitation to mobile communications, for example to environments under LTE, WCDMA, WIMAX and WLAN and can advantageously be implemented in user equipments or smart phones, or personal computers connectable to such networks. That is, it can be implemented as/in chipsets to connected devices, and/or modems or other modules thereof.

If desired, at least some of different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The present invention proposes methods, devices and computer program products in relation to interference reduction, in particular for control channels in TDD systems allowing allocation of flexible subframes for uplink or downlink transmission. In relation thereto, a format of data transmission in flexible subframes in the uplink and/or downlink is modified.

### LIST OF ACRONYMS, ABBREVIATIONS AND DEFINITIONS

### CCE Control Channel Element

### CRC Cyclic Redundancy Check

CRS Common Reference Signal (channel)

### DL Downlink

### DRS Dedicated Reference Signal

### eNB Enhanced Node B. Name for Node B in LTE

HARQ Hybrid Automatic Repeat reQuest

### LA Local Area

### LTE Long Term Evolution

### LTE-A Long Term Evolution Advanced

### MBMS Multimedia Broadcast-Multicast Service

### MBSFN MBMS Single Frequency Network

### OFDM Orthogonal Frequency Division Multiplex

### PCFICH Physical Control Format Indicator Channel

### PDCCH Physical Downlink Control Channel

### PDSCH Physical Downlink Shared Channel

### PHICH Physical Hybrid ARQ Indicator Channel

### PRB Physical Resource Block

### PUSCH Physical Uplink Shared Channel

### RE Resource Element

### RRC Radio Resource Control

### SINR Signal to Interference Noise Ratio

### TDD Time Division Duplex

### UE User Equipment

UL Uplink

1. A device, comprising:
a transceiver module configured for time division duplex (TDD) operation in a network environment, wherein a partition of subframes of channels are configurable to be flexibly assigned for downlink or uplink transmission while other subframes are fixedly configured for either uplink or downlink transmission, and
a controller module, configured to
determine those subframes flexibly assigned for the uplink or downlink transmission, and
modify a format of data transmission in flexible subframes for at least control channels in downlink.

2. A device according to claim 1, wherein
the controller module is further configured to
obtain a value i related to a control format of control channels within subframes, and
modify the format of data transmission such that control channels conveyed within flexible subframes use only the first i symbols out of a number of n OFDM symbols in a subframe.

3. A device according to claim 1, wherein the controller module is configured to
modify the format of data transmission in all flexible subframes in downlink to be a MBSFN subframe format.

4. A device according to claim 1, wherein
the controller module determines the flexible subframes based on exchange of corresponding configuration information with at least one neighboring device so that those subframes assigned for different link directions at different devices are determined to be flexible subframes,
or
the controller module determines the flexible subframes based on its own configuration, by assuming that all subframes except those subframes that are fixed by TDD configuration are flexible subframes.

5. A device according to claim 1, wherein the controller is further configured to signal, to terminals in the coverage of the device, information designating the subframes determined to be flexibly assigned.

6. A device according to claim 2, wherein the controller is further configured to signal, to terminals in the coverage of the device, the value i related to a control format of control channels within flexible subframes.

7. A device according to claim 1, further comprising
instructing to modify the format of data transmission in flexible subframes in uplink dependent on a location of a terminal device within its serving cell.

8. A device according to claim 7, wherein the instructions to modify the format of data transmission is issued if the terminal device is located in a border area of its serving cell, and no instruction to modify the format for data transmission is issued if the terminal device is located in a center area of its serving cell.

9. A device, comprising
a transceiver module configured for time division duplex (TDD) operation in a network environment, wherein a partition of subframes of channels are configurable to be flexibly assigned for downlink or uplink transmission while other subframes are fixedly configured for either uplink or downlink transmission, and
a controller module, configured to
receive an indication of those subframes determined to be flexibly assigned for the uplink or downlink transmission, and
modify a format of data transmission in flexible subframes in uplink.

10. A device according to claim 9, wherein
the controller module is further configured to
receive a value j related to a control format of channels within subframes of a neighboring cell, and
modify the format of data transmission such that control or/and data channels conveyed within flexible subframes use only the last n-j symbols out of a number of n OFDM symbols in a subframe.

11. A device according to claim 9, wherein the controller module is configured to
receive an instruction to modify the format of data transmission in flexible subframes in uplink dependent on a location of a terminal device within its serving cell, and to modify the format of data transmission accordingly.

12. A method, comprising
in a transceiving configuration for time division duplex (TDD) operation in a network environment, wherein a partition of subframes of channels are configurable to be flexibly assigned for downlink or uplink transmission while other subframes are fixedly configured for either uplink or downlink transmission,
determining those subframes flexibly assigned for the uplink or downlink transmission, and
modifying a format of data transmission in flexible subframes for at least control channels in downlink.

13. A method according to claim 12, further comprising
obtaining a value i related to a control format of control channels within subframes, and
modifying the format of data transmission such that control channels conveyed within flexible subframes use only the first i symbols out of a number of n OFDM symbols in a subframe.

14. A method according to claim 12, further comprising
modifying the format of data transmission in all flexible subframes in downlink to be a MBSFN subframe format.

15. A method according to claim 12, further comprising
determining the flexible subframes based on exchange of corresponding configuration information with at least one neighboring device so that those subframes assigned for different link directions at different devices are determined to be flexible subframes,
or
determining the flexible subframes based on its own configuration, by assuming that all subframes except those subframes that are fixed by TDD configuration are flexible subframes.

16. A method according to claim 12, further comprising signaling, to terminals in the coverage of the device, information designating the subframes determined to be flexibly assigned.

17. A method according to claim 13, further comprising
signaling, to terminals in the coverage of the device, the value i related to a control format of control channels within flexible subframes.

18. A method according to claim 12, further comprising
instructing to modify the format of data transmission in flexible subframes in uplink dependent on a location of a terminal device within its serving cell.

19. A method according to claim 18, further comprising issuing the instructions to modify the format of data transmission if the terminal device is located in a border area of its serving cell, and not issuing the instruction to modify the format for data transmission if the terminal device is located in a center area of its serving cell.

20. A method, comprising
in a transceiving configuration for time division duplex (TDD) operation in a network environment, wherein a partition of subframes of channels are configurable to be flexibly assigned for downlink or uplink transmission while other subframes are fixedly configured for either uplink or downlink transmission,
receiving an indication of those subframes determined to be flexibly assigned for the uplink or downlink transmission, and
modifying a format of data transmission in flexible subframes in uplink.

21. A method according to claim 20, further comprising
receiving a value j related to a control format of channels within subframes of a neighboring cell, and
modifying the format of data transmission such that control or/and data channels conveyed within flexible subframes use only the last n-j symbols out of a number of n OFDM symbols in a subframe.

22. A method according to claim 20, further comprising
receiving an instruction to modify the format of data transmission in flexible subframes in uplink dependent on a location of a terminal device within its serving cell, and to modify the format of data transmission accordingly.

23-24. (canceled)
